(19) United States
(12) Patent Application Publication
(10) Pub. No.: US 2009/0313554 A1
(43) Pub. Date: Dec. 17, 2009

(54) EMAIL COMMUNICATIONS THAT INCLUDE A THREAD STATUS INDICATOR

(75) Inventors: THOMAS R. HAYNES, APEX, NC (US); LIN SUN, MORRISVILLE, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/140,745

(22) Filed: Jun. 17, 2008

(51) Int. Cl. G06F 3/048; G06F 15/16

(52) U.S. Cl. 715/752; 709/206

(57) ABSTRACT

A solution for interacting using electronic mail (email) is disclosed. An email thread can be identified, wherein the email thread includes at least a thread initiating email message and at least one response to the thread initiating email message. A thread status indicator can be established for the email thread. The thread status indictor can have a multitude of values. One of the values can reflect that a response has completed the email thread so that additional responses to the thread initiating email message are unnecessary. Another of the values can reflect that no response has completed the email thread so that additional responses to the thread initiating email message are necessary. The thread status indicator can be conveyed to a set of parties participating in the email thread.

### BACKGROUND OF THE INVENTION

The present invention relates to the field of email communications, more particularly to an enhancement for email communications where a series of email communications can be viewed as a thread along with a thread status indicator that is updated as a status of the thread changes.

Email communications are often sent to groups of people concurrently. Responders can choose to reply to only the email originator or to reply to each member of the group (reply all). A Reply-all option is often disfavored because of its tendency to clog email systems of all parties involved. Often, multiple potential responders possess knowledge responsive to the original email request, where the originator of the original message is satisfied so long as one email recipient responds.

At present, multiple responders sometimes duplicate the work of others by providing the same information to the originator, not knowing that other respondents have already “completed” the thread. Other times, no responders will provide an update status to complete the thread, as each potential responder assumes another recipient of the original email message has responded to the email originator. Regardless, determining a thread status can require a reading of multiple email messages, which can be dispersed among other messages making a recipient's inbox difficult to manage. Further, a determination of whether an email thread is completed can be a subjective one, which may not be agreed upon by respondents and/or by an email originator. For example, a respondent may provide a somewhat complete thread response, but realize that this response is tentative and subject to error, which can be minimized by independent confirmation from another responder. In another example, a set of email recipients in a thread may incorrectly assume a thread is completed, when a thread originator is unsatisfied with currently received responses.

Currently no mechanism exists within email technologies that apprises responders as to a current completion status of an email dialog, where a dialog refers to a series of emails spawned from an original email hereafter referred to as an email thread.

### BRIEF DESCRIPTION OF THE SEVERAL VIEWS OF THE DRAWINGS

FIG. 1 is a schematic diagram of a system for an enhancement for email communications for managing, displaying, and changing thread status in accordance with an embodiment of the inventive arrangements disclosed herein.

FIG. 2 shows sample interfaces for exchanging emails having an updatable and displayable thread status indicator in accordance with an embodiment of the inventive arrangements disclosed herein.

FIG. 3 is a flow chart of a method for using an enhancement for email communications for managing and displaying thread status in accordance with an embodiment of the inventive arrangements disclosed herein.

### DETAILED DESCRIPTION OF THE INVENTION

The present invention can allow for an updatable status for email threads. Where an email thread consists of a set of email messages concerning a common topic, which are conveyed among a set of thread participants. In one embodiment of the invention, email communications can be created with thread status support. A thread status option can be enabled for a thread initializing message. Participants in the thread can specify a reply status, which is an indicator established by the respondent as to a current thread status. In one configuration, this reply status can be a tentative status, which must be confirmed by a thread originator before being finalized. In another configuration, a thread originator will establish/change a thread status based upon content of received email messages relevant to the thread. Thread responses can be private between the respondent and the originator and/or published to all thread participants. In one embodiment, an email interface (used by one or more thread participants) can be modified to present a sequence of messages involved in a thread as an expandable object identified by a thread name/heading.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnetic spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

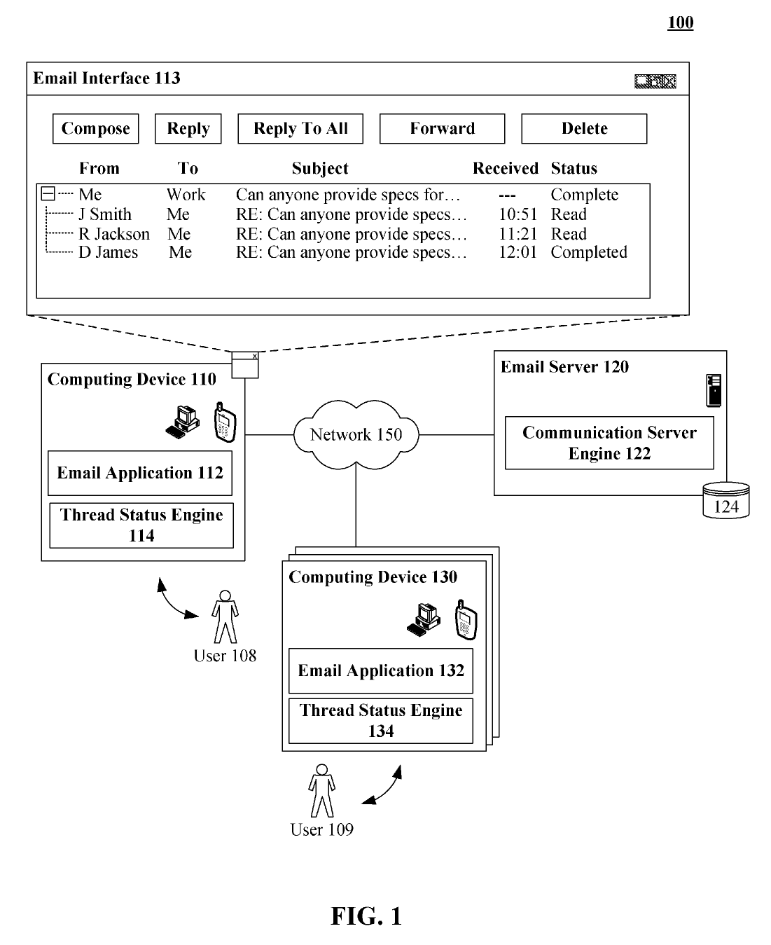

FIG. 1 is a schematic diagram of a system 100 for an enhancement for email communications for managing, displaying, and changing thread status in accordance with an embodiment of the inventive arrangements disclosed herein. System 100 illustrates computing devices 110 and 130 connected via network 150. The computing devices 110 and 130 can access email server 120, which facilitates an exchange of email messages between the devices 110, 130. Each of the email applications 112, 132 residing on computing devices 110, 130 can include a thread status engine 114, 134, which permits a user 108, 109 to update and/or view a status of an email thread. In an alternative embodiment of system 100, the functionality of the thread status engine 114, 134 can be implemented within the email server 120 (e.g., within engine 122) or within a proxy communicatively linked between the devices 110, 130 and server 120. Hybrid embodiments also exist, where some client-side thread based processing (engine 114, 134) can be performed and some server-side thread based processing (engine 122) can be performed.

An email thread can be defined as a series of two or more messages concerning a common topic. An email thread can have at least one thread status, which indicates whether a question posed by the thread has been resolved. For example, thread status indicators can include, no-response, partial response, and complete.

In one embodiment, a thread can have multiple sub-threads, each of which can be associated with a sub-thread indicator. For example, an email thread sent to heads of various divisions partially responsible for a project can query a current status of the project. The thread can include a sub-thread unique to each of the distinct divisions, which has a sub-thread specific status. Thus, a marketing division (associated with Sub-thread A can fully respond to the original email, which causes a status of Sub-thread A to change to completed, which in turn causes a status of the thread to change from no-response to a partial response value. A manufacturing division of the project can responds to a manufacturing specific sub-thread (Sub-thread B), and so forth.

In one embodiment, thread status updates can be provided by any thread participant 108, 109. In another embodiment, a thread originator is given “ownership” of the email thread and must either make or confirm all thread status changes. In still another embodiment, engines 114, 122, and/or 134 can analyze email content and automatically determine status changes for an email thread, which can be directly applied to update the status and/or which may require thread originator confirmation depending upon implementation choices.

Email threads and/or thread status indicators can be an optional email enhancement, which can be implemented in a manner so that even email applications 112, 132 not having a thread status capability can exchange email messages within a thread. For example, if device 110 includes a thread status engine 114 and device 130 does not, email messages can still be exchanged. A user 108 of device 110 can be presented with thread specific options (due to engine 114), while a user 109 of device 130 will not be presented with thread specific options (assuming an absence of engine 134).

In one embodiment, an email interface 113 associated with one or more of the email applications 112, 132 and thread status engines 114-134 can display a thread, thread messages, and/or a thread status. In one example, thread messages can be grouped under a thread heading in a collapsible hierarchy, as shown in interface 113. In another example, a thread history can be presented (under an email message, within a popup, in a special thread section of an email interface) within the interface 113 (not shown) along with a thread status. In still another embodiment, a thread status can appear as a flyover pop-up when a pointer is centered over a message included in a thread. In yet another embodiment, right mouse clicking on an email message can result in a menu appearing that has thread based options, such as viewing a thread status, changing a thread status, etc. Any of a variety of interface implementations for thread status indication and/or modification are contemplated and the invention is not to be limited in this regard.

Computing devices 110 and 130 can be any computing device capable of running communication applications 112 and 132 and thread status engines 114 and 134 respectively. Computing devices 110 and 130 can interact with users 108 and 109. Users 108 and 109 can create email communications using communication applications 112 and 132 respectively. Computing devices 110 and 130 can be any computing device, including, but not limited to, a desktop computer, a laptop computing, a personal data assistant (PDA), a cell phone, or the like.

Thread status engines 114 and 134 can provide the necessary functionality to allow the display and management of email communication threads. Thread status engines 114 and 134 can display email communication thread status in communication applications 112 and 132. Thread status engines 114 and 134 can also provide the functionality to change email communication thread status and update recipients of the change. Thread status engines 114 and 134 can embed thread status information in email communications that can be transferred via server 120 transparently. For example, thread status engines 114 and 134 can embed the data in the header of an email in such a way that it can be conveyed through an email server transparently.

Server engine 122 can provide data exchange communication server functionality. Communication server engine 122 can accept and convey data from communication applications 112 and 132. These communications can include embedded thread status data. Communication server engine 122 can store necessary data, such as account information on data store 124. Communication server engine 122 can provide the email serving functionally, which can include providing a management interface, serving a Web based email client, and otherwise facilitating email exchanges with different email applications 112, 132.

Data store 124 can be physically implemented within any type of hardware including, but not limited to, a magnetic disk, an optical disk, a semiconductor memory, a digitally encoded plastic memory, a holographic memory, or any other recording medium. The data store 124 can be a stand-alone storage unit as well as a storage unit formed from a plurality of physical devices, which may be remotely located from one another. Additionally, information can be stored within each data store in a variety of manners. For example, information can be stored within a database structure or can be stored within one or more files of a file storage system, where each file may or may not be indexed for information searching purposes.

Network 150 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 150 can include local components and data pathways necessary for communications to be exchanged among computing device components and between integrated device components and peripheral devices. The network 150 can also include network equipment, such as routers, data lines, hubs, and intermediary servers which together form a packet-based network, such as the Internet or an intranet. The network 150 can further include circuit-based communication components and mobile communication components, such as telephony switches, modems, cellular communication towers, and the like. The network 150 can include line based and/or wireless communication pathways.

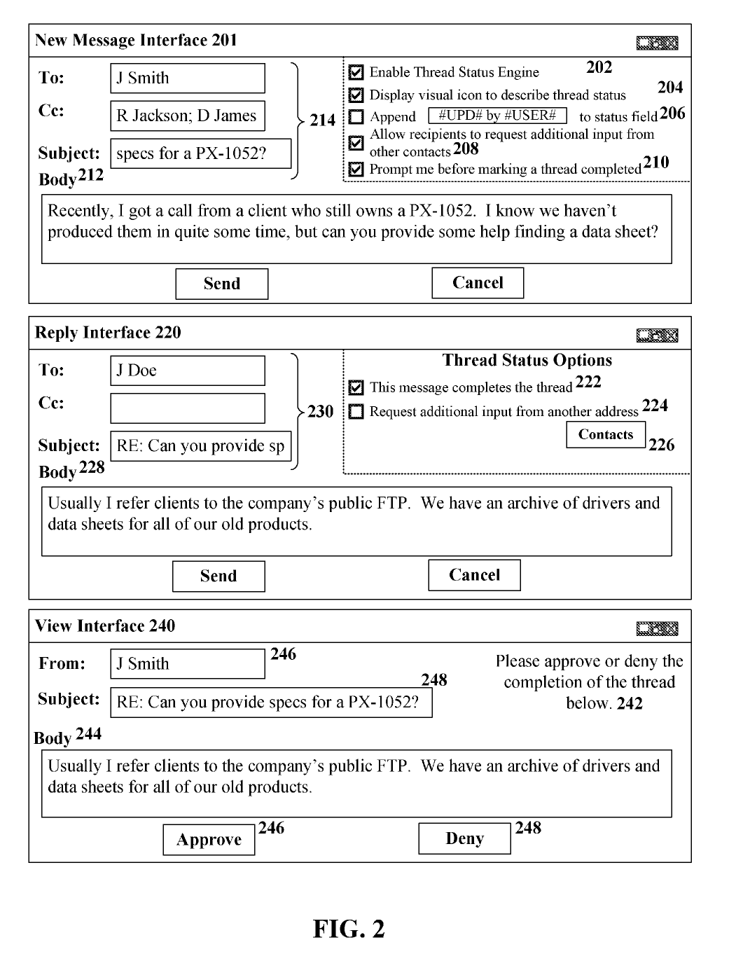

FIG. 2 shows sample interfaces 201, 220, 240 for exchanging emails having an updatable and displayable thread status indicator in accordance with an embodiment of the inventive arrangements disclosed herein. Interface 201 represents an interface through which a new email thread is originated. Interface 220 represents an interface through which a reply to a thread is created. Interface 240 represents an interface through which an originator views a thread response and confirms/denies a respondent provided thread status value. These interfaces 201, 220, 240 are to illustrate concepts described herein and are not to be construed as limitations on contemplated interfaces.

As shown, communication interface 201 can include email communication fields 212 and 214 and thread status options 202-210. Option 202 can be an option to enable or disable thread status functionality on the current email communication. If option 202 is disabled, the use options 204-210 can be disabled. Option 204 can toggle the display of a visual icon to represent the status of the thread on the user's communication client interface. Option 206 can toggle the addition of a formatted string to the status field of the communication. Option 206 can also allow the specification of the formatted string. In interface 201, option 206 has the string “#UPD# by #USER#” specified. It is contemplated that the string can use replaceable tokens such as “#UPD#” and “#USER#” in the formatted string. In this example, the output could produce a translated string such as “Last Updated Jan. 20, 2008 by John” where “#UPD#” can be replaced by the last time the thread has been updated. The token “#USER#” can be replaced by the name of the last contact to update the thread.

Option 208 can toggle allowing recipients requesting additional input from a contact of theirs. In some situations, a recipient can feel that one of their contacts could respond more fully to an email communication and request additional input from that contact. However, in some situations, it may not be desirable to allow a recipient to add additional recipients of the communication. Option 210 can toggle the automatic marking of a thread's completion. If open 210 is disabled, when a reply is received that is marked to complete the thread, the thread can automatically be marked as being completed. If option 210 is enabled, the creator of the email communication can be required to approve the status change of the thread.

New communication interface 201 can also include email communication fields 214, which can include the necessary fields the email communication requires. New communication interface 201 can illustrate an email communication and therefore email communication fields 214 can have standard email input fields (to, cc, bcc, subject). Field 212 can be used to hold the body of the communication. Field 212 can include a request for information to begin the email communication thread.

Reply interface 220 can illustrate an interface to respond to an email communication thread created as illustrated by new communication interface 201. Reply interface 220 can include email communication fields 230, which can be the same necessary email communication fields as email communication fields 214 of interface 201. Body 228 can include the body of the email communication and can include a reply that can complete the thread. Thread status options 222-226 can be available in reply interface 220. Option 222 can toggle whether or not the communication includes the necessary information to complete the thread. In this example, option 222 can be enabled. Option 224 can toggle the requesting of additional input from other contacts. If, for example, option 208 is disabled and the requesting of additional input from other contacts is not allowed, option 224 cannot be displayed or can be disabled. Control 226 can be a button that can allow the specification of contacts to communicate with for additional input.

View interface 240 can illustrate an interface for viewing a response to a thread. The response being viewed in interface 240 can be marked as being able to complete the thread and text 242 can convey this to the user. Interface 240 can include field 246, which can display the contact that has responded to the email communication. Interface 240 can also include field 248, which can display the subject of the email communication response. Body 244 can display the body of the reply, which can be the response send by reply interface 220 in body 228. Interface 240 can prompt the user whether or not to approve or deny the request to mark the thread as completed. Control 246 can be used to approve the request and control 248 can be used to deny it.

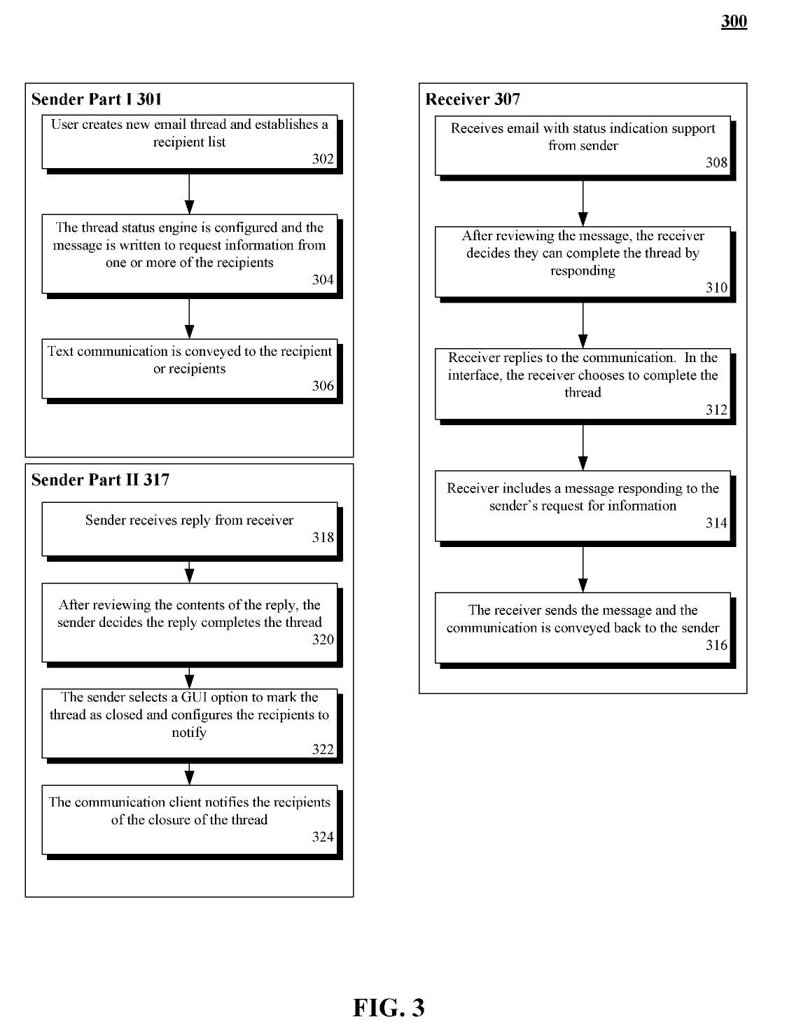

FIG. 3 is a flow chart of a method 300 for using an enhancement for email communications for managing and displaying thread status in accordance with an embodiment of the inventive arrangements disclosed herein. Method 300 can include three separate scenarios, sender part I 301, receiver 307, and sender part II 317 and can be performed in this order. Sender part I 301 can begin in step 302, where a user can create a new email communication and can establish a recipient list. In step 304, the thread status engine can be configured and the message is written to request information from one or more of the recipients. Sender part I can complete in step 306, the email communication can be conveyed to the recipient or recipients.

Method 300 can continue to receiver 307. Receiver 307 can begin in step 308, where the recipient can receive the email communication with thread status indication support from the sender. In step 310, after reviewing the message, the receiver can decide they can complete the thread by responding. In step 312, the receiver can reply to the communication. In the interface, the receiver can choose to complete the thread. In step 314, the receiver can include a message responding to the sender's request for information. Receiver 307 can complete in step 316, where the receiver can send the message and the communication can be conveyed back to the sender.

Method 300 can continue to sender part II 317. Sender part II 317 can begin in step 318, where the sender can receive the reply from the receiver. In step 320, after reviewing the contents of the reply, the sender can decide the reply completes the thread. In step 322, the sender can select a GUI option to mark the thread as closed and can configure the recipients to notify of the completion. Sender part II 317 can complete in step 324, the communication client can notify the configured recipients of the completion of the thread.

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for interacting using electronic mail (email) comprising:
identifying an email thread, wherein the email thread comprises at least a thread initiating email message and at least one response to said thread initiating email message;
establishing a thread status indicator for the email thread, wherein the thread status indictor is configured to have a plurality of values, wherein one of the values reflects that at least one response has completed the email thread so that additional responses to the thread initiating email message are unnecessary, wherein another of the values reflects that no response has completed the email thread so that additional responses to the thread initiating email message are necessary; and
conveying the thread status indicator to a plurality of parties participating in the email thread.

2. The method of claim 1, further comprising:
selectively changing the thread status as new responses are provided to the email thread; and
conveying the changed thread status to each of the parties participating in the email thread.

3. The method of claim 1, wherein the parties participating in the email thread comprise a party who initiated the thread initiating email message, each party receiving the thread initiating message, and each party who submitted a response to the thread initiating email message, wherein each of the parties is associated with a unique email address, which is a unique identifier utilized by an email server to identify each party.

4. The method of claim 1, further comprising:
instantiating an email application having a user interface, wherein the user interface comprises a thread option to selectively initiate an email thread;
creating the thread initiating email message using the user interface; and
selecting the thread option within the user interface when creating the thread initiating email message, wherein the establishing of the thread status indicator occurs based upon user input provided into the user interface.

5. The method of claim 1, further comprising:
receiving the thread initiating email message;
presenting an entry for the thread initiating email message within a user interface of an email application of a party that received the thread initiating email message; and
presenting a current value of the thread status indicator within the user interface, wherein the presented value is associated with the thread initiating email message.

6. The method of claim 5, further comprising:
creating a response to the thread initiating email message using the user interface;
presenting a user interface element to designate whether the created response completes the email thread;
receiving a user input within the presented user interface element that comprises a party-established status indication; and
conveying the created response and the party-established status indication to an email address associated with a creator of the thread initiating email message.

7. The method of claim 6, further comprising:
automatically changing the status of the thread status indicator responsive to a receipt of the party-established status indication; and
conveying the changed thread status to each of the parties participating in the email thread.

8. The method of claim 6, wherein the party-established status indication is a tentative indication, which updates the value of the thread status indicator when the creator programmatically accepts the party-established status indication, and which is discarded without changing the thread status indicator when the creator programmatically denies the party-established status indication.

9. A computer program product for interacting using electronic mail (email) comprising:
a computer usable medium having computer usable program code embodied therewith, the computer usable program code comprising:
computer usable program code configured to identify an email thread, wherein the email thread comprises at least a thread initiating email message and at least one response to said thread initiating email message;
computer usable program code configured to establish a thread status indicator for the email thread, wherein the thread status indictor is configured to have a plurality of values, wherein one of the values reflects that at least one response has completed the email thread so that additional responses to the thread initiating email message are unnecessary, wherein another of the values reflects that no response has completed the email thread so that additional responses to the thread initiating email message are necessary; and
computer usable program code configured to convey the thread status indicator to a plurality of parties participating in the email thread.

10. The computer program product of claim 9, further comprising:
computer usable program code configured to selectively change the thread status as new responses are provided to the email thread; and
computer usable program code configured to convey the changed thread status to each of the parties participating in the email thread.

11. The computer program product of claim 9, wherein the parties participating in the email thread comprise a party who initiated the thread initiating email message, each party receiving the thread initiating message, and each party who submitted a response to the thread initiating email message, wherein each of the parties is associated with a unique email address, which is a unique identifier utilized by an email server to identify each party.

12. The computer program product of claim 9, further comprising:
computer usable program code configured to instantiate an email application having a user interface, wherein the user interface comprises a thread option to selectively initiate an email thread;
computer usable program code configured to create the thread initiating email message using the user interface; and
computer usable program code configured to select the thread option within the user interface when creating the thread initiating email message, wherein the establishing of the thread status indicator occurs based upon user input provided into the user interface.

13. The computer program product of claim 9, further comprising:
computer usable program code configured to receive the thread initiating email message;
computer usable program code configured to present an entry for the thread initiating email message within a user interface of an email application of a party that received the thread initiating email message; and
computer usable program code configured to present a current value of the thread status indicator within the user interface, wherein the presented value is associated with the thread initiating email message.

14. The computer program product of claim 13, further comprising:
computer usable program code configured to create a response to the thread initiating email message using the user interface;
computer usable program code configured to present a user interface element to designate whether the created response completes the email thread;
computer usable program code configured to receive a user input within the presented user interface element that comprises a party-established status indication; and
computer usable program code configured to convey the created response and the party-established status indication to an email address associated with a creator of the thread initiating email message.

15. The computer program product of claim 14, further comprising:
computer usable program code configured to automatically change the status of the thread status indicator responsive to a receipt of the party-established status indication; and
computer usable program code configured to convey the changed thread status to each of the parties participating in the email thread.

16. The computer program product of claim 14, wherein the party-established status indication is a tentative indication, which updates the value of the thread status indicator when the creator programmatically accepts the party-established status indication, and which is discarded without changing the thread status indicator when the creator programmatically denies the party-established status indication.

17. A user interface of an email application comprising:
at least one interface element associated with created and received email messages indicating that at least a portion of the email messages are messages belonging to an email thread, wherein the email thread comprises at least a thread initiating email message and at least one response to said thread initiating email message;
at least one thread status indictor associated with the email messages, wherein the thread status indictor is configured to have a plurality of values, wherein one of the values reflects that at least one response has completed the email thread so that additional responses to the thread initiating email message are unnecessary, wherein another of the values reflects that no response has completed the email thread so that additional responses to the thread initiating email message are necessary; and
a status change control configured to permit a user to designate a new value for a thread status indictor associated with one of the email messages.

18. The user interface of claim 17, further comprising:
a grouping control configured to group all email messages by email thread, wherein the grouping control is able to be selectively expanded and contracted responsive to user selections, wherein when expanded, all email message associated with an email thread are presented within the user interface, wherein when contracted at least one email message associated with the email thread is hidden.

19. The user interface of claim 17, further comprising:
an originator status change configuration option associated with a creation of an email message that is a thread initiating email message, wherein when enabled a creator of a thread initiating email message is required to confirm a party created status indicator before a value of the thread status indicator is able to be changed, wherein when the originator status change confirmation option is disabled any party receiving the thread initiating email message is able to change the thread status indictor when responding to the thread initiating email message.
